(19) United States
(12) Patent Application Publication
(10) Pub. No.: US 2006/0012651 A1
(43) Pub. Date: Jan. 19, 2006

(54) Inkjet cartridge

(76) Inventors: Young-Su Lee, Yongin-si (KR); Jae-Cheol Lee, Hwaseong-gun (KR)

Correspondence Address: STANZIONE & KIM, LLP, 919 18TH STREET, N.W., SUITE 440, WASHINGTON, DC, 20006, US

(21) Appl. No.: 11/041,391

(22) Filed: Jan. 25, 2005

(30) Foreign Application Priority Data
Jul. 16, 2004 (KR) 2004-55761

(51) Int. Cl. B41J 2/175

(52) U.S. Cl. 347/86

(57) ABSTRACT

An inkjet cartridge includes a cartridge body provided with an ink storing space to store ink therein, a lid mounted on an upper portion of the cartridge body to seal the cartridge body, a head chip mounted on a lower portion of the cartridge body to eject the ink stored in the cartridge body, and an elastic member mounted on the cartridge body to absorb an impact transmitted to the head chip. Therefore, an impact applied from an exterior of the cartridge body is blocked and absorbed by the elastic member before the impact is applied to the head chip. As a result, a crack phenomenon of the head chip due to the external impact is fully prevented.

### CROSS-REFERENCE TO RELATED APPLICATIONS

This application claims the benefit of Korean Patent Application No. 2004-55761, filed Jul. 16, 2004, the disclosure of which is hereby incorporated herein by reference in its entirety.

### BACKGROUND OF THE INVENTION

1. Field of the Invention

The present general inventive concept relates to an inkjet cartridge, and more particularly, to an inkjet cartridge capable of preventing a crack phenomenon of a head chip.

2. Description of the Related Art

An inkjet cartridge is a device for printing a predetermined image on a recording medium by ejecting ink stored in an interior part toward an exterior in a droplet shape, and is typically used in a state where the inkjet cartridge is mounted on a carriage of an inkjet printer, which is movable in a width direction of the recording medium.

Such an inkjet cartridge includes a cartridge body provided with a predetermined space therein to store the ink, a head chip mounted on a bottom surface of the cartridge body to eject the ink stored in the cartridge body to a desired position of the recording medium through a nozzle portion thereof, and a lid mounted on an upper portion of the cartridge body to seal an open portion of a top surface of the cartridge body.

Specifically, the cartridge body is provided with a negative pressure maintaining unit for maintaining the inside of the cartridge body at a predetermined negative pressure, and a filter for filtering the ink supplied into the head chip at a lower portion of the cartridge body. At this time, the negative pressure maintaining unit conventionally uses foam.

In addition, a head chip for ejecting the ink is attached to a lower portion of the filter, i.e., a bottom surface of the cartridge body using an adhesive agent such as a sealant.

Further, the lid is fusion-bonded to the upper portion of the cartridge body by an ultrasonic wave, etc., the lid including an inner lid provided with an ink supply hole and an outer lid mounted on an upper portion of the inner lid.

Therefore, a conventional inkjet cartridge is assembled by the following order and comes onto the market.

First, when the filter is mounted in the cartridge body, an operator attaches the head chip to the bottom surface of the cartridge body using an adhesive agent etc.

Then, after the head chip is attached to the cartridge body, a predetermined amount of foam is inserted into the cartridge body.

Continuously, after the foam is inserted, the inner lid is fusion-bonded to the upper portion of the cartridge body.

Then, after the inner lid is fusion-bonded, a predetermined amount of ink is introduced into the cartridge body through the ink supply hole formed at the inner lid.

Then, after the ink is introduced into the cartridge body, the outer lid is fusion-bonded to the upper portion of the cartridge body, i.e., the upper portion of the inner lid, by the ultrasonic wave. When the assembly of the inkjet cartridge is completed, the operator finally performs impact and drop tests for the assembled inkjet cartridge, and then the inkjet cartridges come onto the market.

However, such a conventional inkjet cartridge has various problems.

First, since the conventional inkjet cartridge is provided with the head chip directly attached to the cartridge body, an impact applied from an exterior of the inkjet cartridge during the impact and drop tests is directly transmitted to the head chip. As a result, the head chip has a problem in that a crack is often generated therein. Therefore, the cracked head chip not only makes a state of the ink ejection unstable but also causes leakage of the ink.

In addition, the foam is inserted in the conventional inkjet cartridge to absorb ultrasonic energy for fusion bonding while the outer lid and the cartridge body are fusion-bonded. Although bubbles due to the ultrasonic wave are not generated at a portion where the foam is inserted, there occurs a problem in that, when the outer lid and the cartridge body are ultrasonically bonded, the ultrasonic energy for the fusion bonding is directly transmitted to the head chip attached to the cartridge body and the ink at the upper portion of the head chip along the cartridge body, because no means for absorbing the ultrasonic energy is provided around the head chip of the inkjet cartridge, i.e., at the lower portion of the filter. Therefore, a great deal of bubbles are generated in the ink contained in the head chip and the ink located at the upper portion of the head chip by the transmitted ultrasonic energy, thus the bubbles are fully filled in the ink supply hole of the head chip and the nozzle portion, at which the ink is ejected, thereby lowering reliability of the ink ejection.

### SUMMARY OF THE INVENTION

The present general inventive concept provides an inkjet cartridge capable of minimizing an impact applied to a head chip during impact and drop tests for the inkjet cartridge.

The present general inventive concept also provides an inkjet cartridge capable of minimizing generation of bubbles by absorbing ultrasonic energy applied around a head chip by a certain amount.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing an inkjet cartridge including a cartridge body provided with an ink storing space to store ink therein, a lid mounted on an upper portion of the cartridge body to seal the cartridge body, a head chip mounted on a lower portion of the cartridge body to eject the ink stored in the cartridge body, and at least one elastic member mounted on the cartridge body to absorb an impact transmitted to the head chip.

A plurality of elastic members may be mounted around the head chip.

The elastic members can be mounted at both sides of the head chip.

The elastic members can be mounted around the head chip and at corners of the cartridge body, respectively.

The elastic members can be mounted around the head chip and on edges of the cartridge body, respectively.

The elastic members may be formed of rubber or silicone.

The foregoing and/or other aspects and advantages of the present general inventive concept may also be achieved by providing an inkjet cartridge including a cartridge body provided with an ink storing space to store ink therein, a lid mounted on an upper portion of the cartridge body to seal the cartridge body, a head chip mounted on a lower portion of the cartridge body to eject the ink stored in the cartridge body, at least one elastic member mounted on the cartridge body to absorb an impact transmitted to the head chip, and a flexible printed circuit board electrically connected to edges of the head chip and covering edges and the elastic member.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating an inkjet cartridge according to an embodiment of the present general inventive concept;

FIG. 2 is an enlarged perspective view of a portion A of FIG. 1;

FIG. 3 is an exploded perspective view in which an FPC is separated from the inkjet cartridge shown in FIG. 1;

FIG. 4 is an exploded perspective view in which a head chip and an elastic member are separated from the inkjet cartridge shown in FIG. 3;

FIG. 5 is a partial cross-sectional view of taken along a line I-I′ of FIG. 1;

FIG. 6 is a perspective view illustrating an inkjet cartridge according to an embodiment of the present general inventive concept;

FIG. 7 is a perspective view illustrating an inkjet cartridge according to an embodiment of the present general inventive concept; and

FIG. 8 is a perspective view illustrating an inkjet cartridge according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

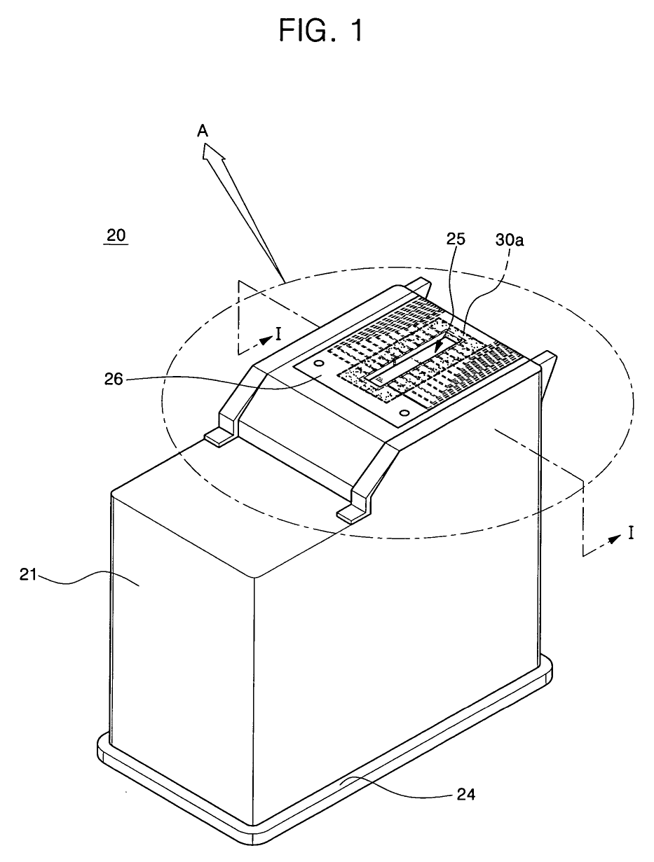

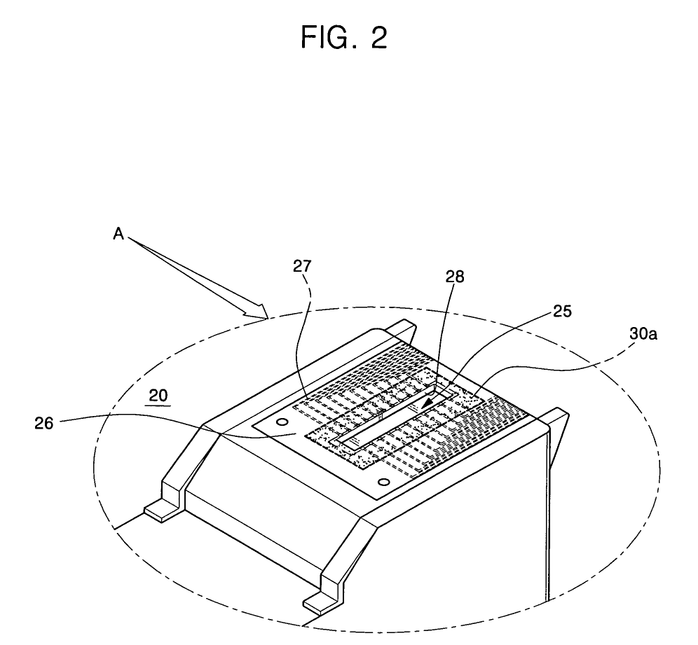

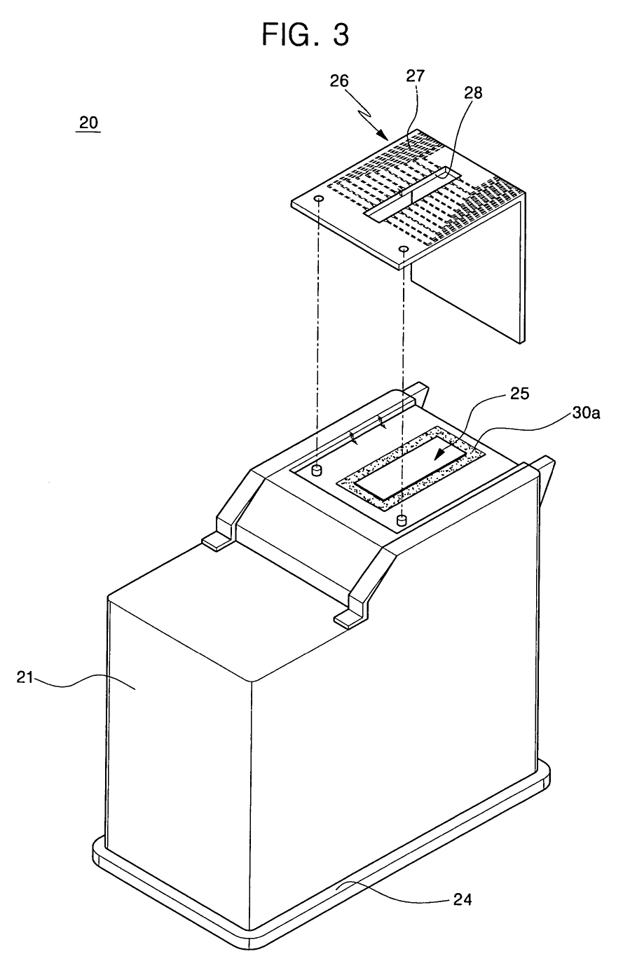

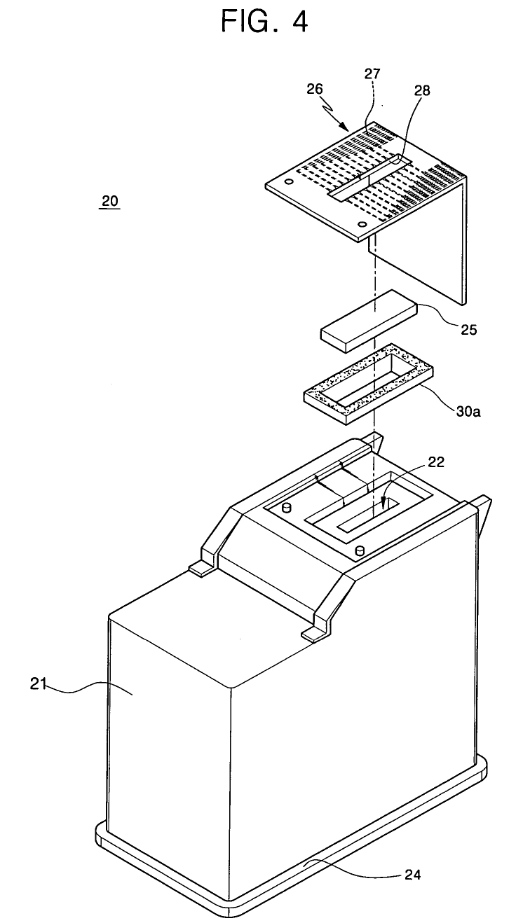

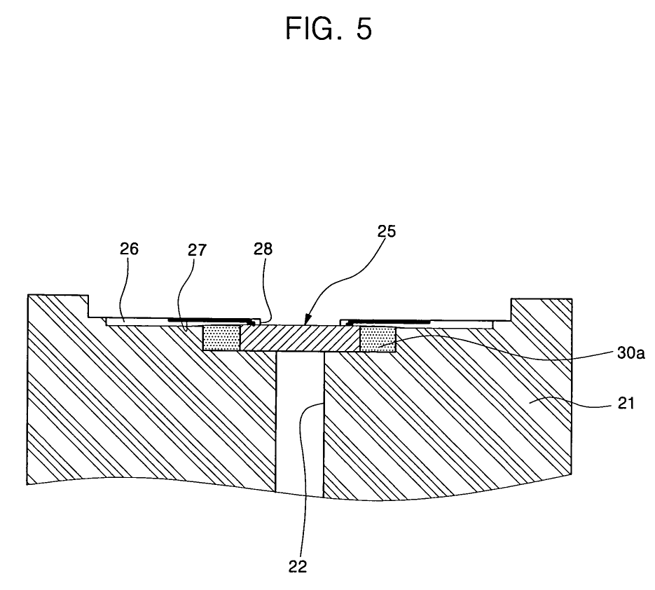

Hereinafter, an inkjet cartridge 20 according to embodiment of the present general inventive concept will be described in more detail with reference to FIGS. 1 to 8.

Referring to FIGS. 1-5, the inkjet cartridge 20 includes a cartridge body 21 provided with an ink storing space to store ink therein, a lid mounted on an upper portion of the cartridge body 21 to seal the cartridge body 21, a head chip 25 mounted on a lower portion of the cartridge body 21 to eject the ink stored in the cartridge body 21, and an elastic member 30a mounted on the cartridge body 21 to absorb an impact transmitted toward the head chip 25. The inkjet cartridge 20 may include a flexible printed circuit (FPC) 26 having an opening 28 through which nozzles of the head chip 25 are exposed. The FPC 26 may have a conductive line 27 formed therein to electrically connect the head chip 26 to an external circuit to eject the ink through the nozzles of the head chip 26.

Specifically, the cartridge body 21 is formed in a shape of enclosure, and provided with an ink supply passage 22 at its lower portion and a hole to receive the ink supplied from an external source at its upper portion. Therefore, the ink supplied from the external source is introduced through the hole, and then supplied to the head chip 25 through the ink supply passage 22.

In addition, a filter (not shown) is mounted at an upper side of the ink supply passage 22 to filter the ink, and the filtered ink is supplied into the head chip 25.

Further, a unit to maintain a negative pressure (not shown) is installed at the upper portion of the filter, i.e., in the cartridge body 21 to maintain an inside of the cartridge body at the negative pressure. Therefore, the ink stored in the cartridge body 21 does not arbitrarily leak due to such an interior negative pressure. At this time, the negative pressure maintaining unit can adopt a spring or foam, etc., to generate the negative pressure.

Meanwhile, the lid is fusion-bonded to the upper portion of the cartridge body 21 using a ultrasonic wave, etc., and includes an inner lid (not shown) having an ink supply hole, and an outer lid 24 mounted on an upper portion of the inner lid to hermetically seal the cartridge body 21. Therefore, the inner lid is fusion-bonded to the cartridge body 21, and then the outer lid 24 is fusion-bonded to the cartridge body 21 to seal the cartridge body 21.

In addition, the head chip 25 to eject the ink is attached to the cartridge body 21 at the lower portion of the ink supply passage 22, i.e., a bottom surface of the cartridge body 21 to communicate with the ink supply passage 22. At this time, the head chip 25 can be attached to the cartridge body 21 by an adhesive agent, etc. Specifically, the head chip 25 includes a plurality of chambers (not shown) for receiving the ink supplied through the ink supply passage 22 by a certain amount, the nozzles (not shown) formed at a lower side of each chamber, ink ejection devices respectively installed at the chamber to eject the ink in the chambers through the nozzles according to external signals transmitted through a conductor formed therein and the conductive line 27 of the FPC 26, and a plurality of pads to respectively apply a power source to each ink ejection device. At this time, the nozzles are formed at a center of the head chip, and each of the pads is formed at an edge of the head chip.

Meanwhile, the elastic member 30a is formed of an elastic material such as rubber or silicone, etc., and functions to absorb the impact (at this time, “impact” represents herein to include not only a mechanical impact but also any wave or vibration, etc.) transmitted to the head chip 25 from an exterior or an interior of the cartridge body 21. At this time, when the elastic member 30a is formed of the rubber, etc., the elastic member 30a is attached to the cartridge body 21 after the elastic member 30a is processed to have a predetermined shape. On the other hand, when the elastic member 30a is formed of the silicone, etc., the elastic member 30a is applied on the cartridge body 21 in a predetermined shape. In addition, the elastic member 30a may be mounted on any portion of the cartridge body 21 capable of blocking the impact transmitted to the head chip 25 from the exterior or the interior and absorbing the impact, since the elastic member 30a functions to absorb the impact from the exterior or the interior.

As shown in FIGS. 1 to 5, the elastic member 30a can be mounted around the head chip 25, i.e., on a peripheral portion of the head chip 25. At this time, the elastic member 30a may be formed in a rectangular panel or a frame type provided with the opening having a size equal to the head chip at its center. Therefore, a crack phenomenon generated from a conventional inkjet cartridge is prevented since the impact applied from the exterior during the impact and drop tests for the cartridge 20 is blocked and absorbed by the elastic member 30a around the head chip 25 before the impact is applied to the head chip 25 by inserting the head chip 25 into the center of the elastic member 30a having the rectangular panel shape. In addition, a bubble problem caused by a conventional ultrasonic wave is minimized since the elastic member 30a is capable of absorbing ultrasonic energy generated and transmitted during the fusion bonding of the outer lid 24.

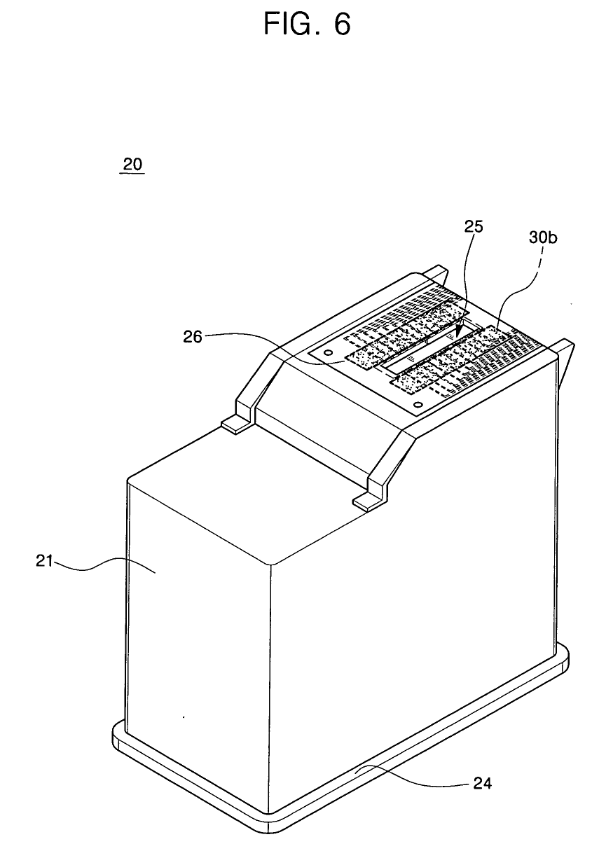

As shown in FIG. 6, a second elastic member 30b can be mounted only may be on both sides of the head chip 25. In this case, the elastic members 30b may be formed of an elongated rectangular plate type longer than the head chip 25.

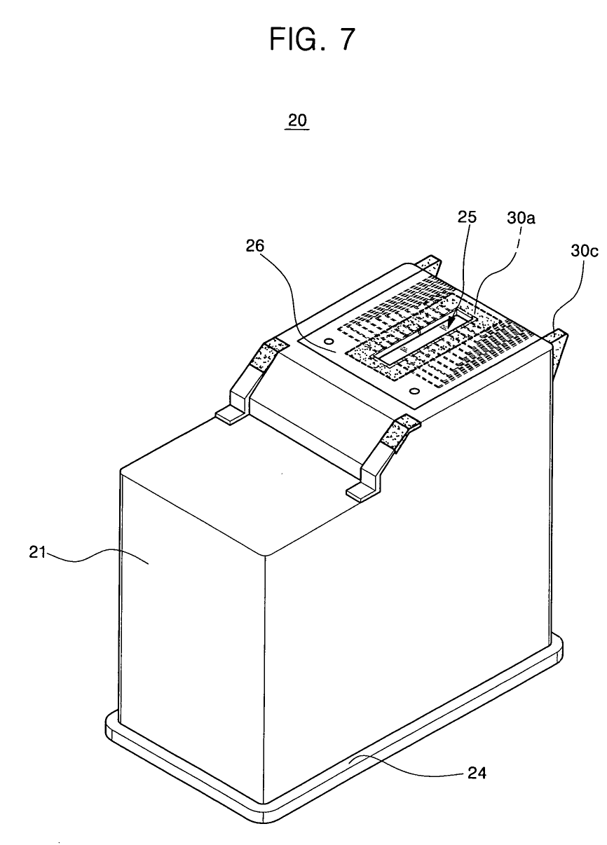

In addition, as shown in FIG. 7, the elastic member 30a and a third elastic member 30c may be mounted around the head chip 25 and at corners of the cartridge body 21, respectively. In this case, the elastic member 30a (FIG. 7) mounted around the head chip 25 is formed in the same shape as the elastic member 30a of FIG. 1, and the elastic member 30c mounted on the cartridge body 21 is formed in a shape of surrounding the corners of the cartridge body 21 or a protrusion shape protruded from the cartridge body 21 by a predetermined size. The second elastic member 30b of FIG. 6 may be used together with the third elastic member 30c. Therefore, when the elastic members 30a and 30c are mounted on the cartridge body 21, the elastic members 30a and 30c are capable of absorbing twice the external impact transmitted through the corners of the cartridge body 21 while the impact and drop tests are performed. As a result, the external impact is not substantially transmitted to the head chip 25 or minimally transmitted.

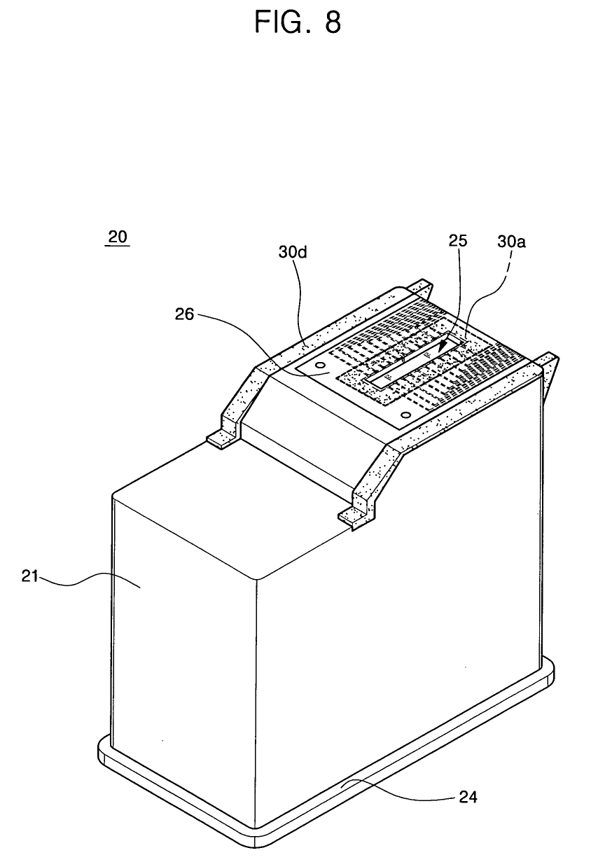

In addition, as shown in FIG. 8, the elastic member 30a and a fourth elastic member 30d can be mounted around the head chip 25 and on edges of the cartridge body 21, respectively. In this case, the elastic member 30a mounted around the head chip 25 is formed in the same shape as the elastic member 30a FIG. 1, and the elastic member 30d mounted on the cartridge body 21 is formed in a shape of surrounding the edges of the cartridge body 21. The second elastic member 30b of FIG. 6 can be used together with the fourth elastic member 30d. Therefore, when the elastic members 30a and 30d are mounted on the cartridge body 21, the elastic members 30a and 30d are capable of absorbing twice the external impact transmitted through the edges of the cartridge body 21 during the impact and drop tests, similar to the third embodiment. Therefore, the head chip 25 is protected from the external impact, etc.

Meanwhile, the inkjet cartridge 20 is used in a state where it is mounted on a carriage (not shown), etc., of an inkjet printer movable in a width direction of a recording medium. Therefore, the carriage reciprocally moves the inkjet cartridge 20 in the width direction of the recording medium depending upon an image type to be formed on the recording medium. As a result, the inkjet cartridge 20 is reciprocally moved in the width direction of the recording medium by the carriage to form a predetermined image on the recording medium.

At this time, the inkjet cartridge 20 is not simply mounted on the carriage, but it is brought into electrical contact with the carriage to receive predetermined signals from the carriage, wherein one side of the inkjet cartridge 20 is brought into contact with one side of the carriage. Therefore, the inkjet cartridge 20 selectively ejects the ink stored therein to form the predetermined image on the recording medium depending upon the signals inputted through the carriage.

Meanwhile, the inkjet cartridge 20 is provided with a circuit board to electrically connect from one side of the cartridge body 21 brought into electrical contact with the carriage to the head chip 25 attached to the bottom surface of the cartridge body 21. Therefore, the predetermined signals inputted through the carriage are transmitted to the devices including the pads of the head chip 25 through the circuit board, respectively. At this time, the circuit board can be the flexible printed circuit (FPC) 26. In this connection, the FPC 26 may be electrically connected to some portions of the head chip 25, i.e., edges of the head chip, through the conductive line 27. In addition, the FPC 26 mounted on the cartridge body 21 may cover the elastic members 30a, 30b, 30c, and 30d mounted on the edges of the head chip 25 and around the head chip 25, respectively. In addition, the FPC 26 is provided with the opening 28 having a predetermined size to expose a portion, at which the nozzle is formed, of the head chip 25, i.e., a center of the head chip.

Hereinafter, an assembly procedure and an operating effect thereof of the inkjet cartridge 20 of FIGS. 1, 6, 7, or 8 will be more specifically described. As an example for the purpose of description of the assembly procedure, the elastic member 30a is mounted only around (peripheral portion of) the head chip 25 as shown in FIGS. 1 to 5, and the negative pressure maintaining unit uses the foam.

First, when the filter is mounted in the cartridge body 21, the elastic member 30a, such as rubber, is attached to a bottom surface of the cartridge body 21 using an adhesive agent, etc. When silicone is used as the elastic member 30a, the silicone is applied on the bottom surface of the cartridge body 21 to be attached to the cartridge body 21.

Then, after the elastic member 30a is attached, the head chip 25 is attached to the cartridge body 21 at a center of the elastic member 30a.

Continuously, after the head chip 25 is attached, a predetermined amount of foam is inserted into the cartridge body 21.

Then, after the foam is inserted, the inner lid is fusion-bonded to an upper portion of the cartridge body 21.

Continuously, after the inner lid is fusion-bonded, a predetermined amount of ink is introduced into the cartridge body 21 through the ink supply hole formed at the inner lid.

Then, the ink is introduced, the outer lid is ultrasonically fusion-bonded to the upper portion of the cartridge body 21, i.e., an upper portion of the inner lid. As a result, the assembly of the inkjet cartridge 20 is completed. Therefore, the impact and drop tests for the inkjet cartridge 20 assembled as above are finally performed, and then the inkjet cartridge 20 comes onto the market.

At this time, since the inkjet cartridge 20 is provided with the elastic member 30a, 30b, 30c, or 30d around the head chip 25, etc., when the impact and drop tests are performed, the impact applied from the exterior is previously blocked and absorbed by the elastic member 30a, 30b, 30c, or 30d before the impact is applied to the head chip. Therefore, the crack phenomenon of a conventional head chip is prevented.

In addition, since the elastic member 30a, 30b, 30c, or 30d also absorbs a certain amount of ultrasonic energy generated and transmitted during the fusion bonding of the lid, the bubbles in the ink generated by the ultrasonic energy are also remarkably reduced. Therefore, a reliability problem of the ink ejection due to the bubbles is fully prevented.

As described above, since the inkjet cartridge can be provided with the elastic member around the head chip 25, etc., when the impact and drop tests are performed, the impact applied from the exterior is previously blocked and absorbed by the elastic member 30a, 30b, 30c, or 30d before the impact is applied to the head chip. Therefore, since the external impact is not substantially transmitted to the head chip, the crack phenomenon of the conventional head chip is fully prevented.

In addition, since the elastic member 30a, 30b, 30c, or 30d mounted on the cartridge body 21 also absorbs a certain amount of ultrasonic energy generated and transmitted during the fusion bonding of the lid, only a minimum amount of ultrasonic energy may be transmitted to the ink stored in the head chip of the cartridge body. Therefore, the bubbles in the ink generated by the ultrasonic energy are also remarkably reduced. Therefore, a reliability problem of the ink ejection due to the bubbles is fully prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An inkjet cartridge comprising:
a cartridge body having an ink storing space to store ink therein;
a head chip mounted on the cartridge body to eject the ink stored in the ink storing space of the cartridge body; and
at least one elastic member mounted between the head chip and the cartridge body to absorb an impact transmitted toward the head chip.

2. The inkjet cartridge according to claim 1, wherein the at least one elastic member is mounted around the head chip.

3. The inkjet cartridge according to claim 2, wherein the at least one elastic member is made of one of rubber and silicone.

4. The inkjet cartridge according to claim 1, wherein the at least one elastic member comprises a plurality of elastic members mounted on both sides of the head chip.

5. The inkjet cartridge according to claim 4, wherein the elastic members are made of one of rubber and silicone.

6. The inkjet cartridge according to claim 1, wherein the at least one elastic member comprises a plurality of elastic members mounted around the head chip and on corners of the cartridge body, respectively.

7. The inkjet cartridge according to claim 6, wherein the elastic members are made of one of rubber and silicone.

8. The inkjet cartridge according to claim 1, wherein the at least one elastic member comprises a plurality of elastic members mounted around the head chip and on edges of the cartridge body, respectively.

9. The inkjet cartridge according to claim 8, wherein the elastic members are made of one of rubber and silicone.

10. The inkjet cartridge according to claim 1, further comprising:
a lid mounted on the cartridge body to seal the cartridge body to prevent the ink from leaking from the cartridge body.

11. The inkjet cartridge according to claim 10, wherein the lid is fusion-bonded to the cartridge body using ultrasonic energy, and the at least one elastic member absorbs the ultrasonic energy transmitted toward the head chip during fusion-bonding of the lid to the cartridge body.

12. The inkjet cartridge according to claim 1, wherein the at least one elastic member is made of a material to absorb both an ultrasonic wave and the impact.

13. The inkjet cartridge according to claim 1, wherein the at least one elastic member is made of a material having elasticity lower than that of the cartridge body.

14. (canceled)

15. The inkjet cartridge according to claim 1, further comprising:
an adhesive agent disposed between a portion of the head chip and a portion of the cartridge body to attach the head chip to the cartridge body,
wherein the at least one elastic member comprises a first surface disposed on another portion of the head chip and a second surface disposed on another portion of the cartridge body.

16. The inkjet cartridge according to claim 1, wherein the at least one elastic member comprises a first elastic member mounted on a first surface of the cartridge body between the head chip and the cartridge body and a second elastic member mounted on a second surface of the cartridge body.

17. The inkjet cartridge according to claim 16, wherein the head chip is not disposed on the second surface of the cartridge body.

18. The inkjet cartridge according to claim 16, wherein the head chip and the first elastic member are disposed on the first surface of the cartridge body.

19. The inkjet cartridge according to claim 1, further comprising:
a printed circuit board electrically connected to the head chip to cover the at least one elastic member and a portion of the head chip.

20. The inkjet cartridge according to claim 19, wherein the head chip and the at least one elastic member are mounted on a first surface of the cartridge body, and the printed circuit board is attached to a second surface of the cartridge body and extended to cover the at least one elastic member and the portion of the head chip.

21. An inkjet cartridge comprising:
a cartridge body having an ink storing space to store ink therein;
a lid mounted on a portion of the cartridge body to seal the cartridge body;
a head chip mounted on the cartridge body to eject the ink stored in the ink storing space of the cartridge body;
at least one elastic member mounted between the head chip and the cartridge body to absorb an impact transmitted toward the head chip; and
a flexible printed circuit board electrically connected to edges of the head chip, and to cover the edges of the head chip and the at least one elastic member.

22. The inkjet cartridge according to claim 21, wherein the at least one elastic member is mounted around the head chip.

23. The inkjet cartridge according to claim 22, wherein the at least one elastic member is made of one of rubber and silicone.

24. The inkjet cartridge according to claim 21, wherein the at least one elastic member comprises a plurality of elastic members mounted on both sides of the head chip.

25. The inkjet cartridge according to claim 24, wherein the elastic members are made of one of rubber and silicone.

26. The inkjet cartridge according to claim 21, wherein the at least one elastic member comprises a plurality of elastic members mounted around the head chip and on corners of the cartridge body, respectively.

27. The inkjet cartridge according to claim 26, wherein the elastic members are made of one of rubber and silicone.

28. The inkjet cartridge according to claim 21, wherein the at least one elastic member comprises a plurality of elastic members mounted around the head chip and on edges of the cartridge body, respectively.

29. The inkjet cartridge according to claim 28, wherein the elastic members are made of one of rubber and silicone.

30. An inkjet cartridge, comprising:
a cartridge body having an ink supply passage extending therethrough to a bottom surface of the cartridge body;
an inkjet head disposed on the bottom surface of the cartridge body to receive ink through the ink supply passage; and
at least two first elastic members disposed on outer edges of the bottom surface of the cartridge body.

31. The inkjet cartridge according to claim 30, wherein the inkjet head is disposed in a recess disposed about the ink supply passage at the bottom surface of the cartridge body, and the inkjet cartridge further comprises:
a second elastic member disposed in the recess between the inkjet head and the cartridge body and in contact therewith.

32. An inkjet cartridge, comprising:
a cartridge body having an ink storing space to store ink therein;
a head chip mounted on the cartridge body to eject the ink stored in the ink storing space of the cartridge body; and
at least one elastic member mounted on the cartridge body to absorb an impact transmitted toward the head chip,
wherein the at least one elastic member is made of a material to absorb both an ultrasonic wave and the impact.
